(19) United States
(12) Patent Application Publication
(10) Pub. No.: US 2026/0288149 A1
(43) Pub. Date: Sep. 24, 2026

(54) CONTROL SYSTEM, CONTROL METHOD, AND CONTROL PROGRAM

(71) Applicant: NEC Corporation, Tokyo (JP)

(72) Inventors: Eiichi TOKUMI, Tokyo (JP); Kenichi KIJIMA, Tokyo (JP); Tetsuya TANABIKI, Tokyo (JP); Takahiro MIZUTA, Tokyo (JP); Taichi SEISHI, Tokyo (JP); Takuya NOMURA, Tokyo (JP); Takumi KAMLYAMA, Tokyo (JP)

(73) Assignee: NEC Corporation, Tokyo (JP)

(21) Appl. No.: 19/164,275

(22) PCT Filed: Dec. 13, 2023
(86) PCT No.: PCT/JP2023/044613

§ 371 Date: Sep. 11, 2025

(30) Foreign Application Priority Data
Mar. 24, 2023 (JP) 2023-048277

(51) Int. Cl. G05D 1/622; G05D 1/606; G05D 1/69; G05D 107/10; G05D 109/20; G05D 111/10

(52) U.S. Cl. CPC G05D 1/622; G05D 1/606; G05D 1/69; G05D 2107/10; G05D 2109/20; G05D 2111/10

(57) ABSTRACT

The purpose of the present disclosure is to provide a control system, a control method, and a control program with which it is possible to achieve safe flight of a moving body even in locations where the operator cannot visually observe the moving body. The movement information acquisition unit acquires movement information including the progress of the moving body with respect to a flight plan. The environmental information acquisition unit acquires environmental information associated with the flight of the moving body from a monitoring device that monitors the movement path of the moving body. The recommended action selection unit selects a recommended action according to the progress of the moving body on the basis of the movement information and the environmental information. The output unit outputs a signal indicating the action recommended by the recommended action selection unit.

### BACKGROUND ART

### Technical Field

The use of moving bodies such as drones that move in the air is increasing. Along with this, non-visual observation flight of the operator is started. In the non-visual observation flight, it is required to avoid danger quickly and safely.

PTL 1 describes a driving assistance device that enables a moving body traveling on a road to avoid danger on the road. In the driving assistance device disclosed in PTL 1, a road danger degree is calculated based on whether it is a road on which a moving body can travel, and a potential danger degree on a travel route of the moving body in a target time range is calculated based on a traffic condition and a moving range of the moving body. In the driving assistance device disclosed in PTL 1, an action for avoiding danger is selected based on the road danger degree and the potential danger degree.

### CITATION LIST

### Patent Literature

PTL 1: Japanese Patent Publication No. 6956932

### SUMMARY OF INVENTION

### Technical Problem

In the driving assistance device disclosed in PTL 1 described above, a danger on a road is calculated, but a moving body flying in the air requires information that was not a problem on the road to calculate the danger. Therefore, it is difficult to achieve safe flight with the driving assistance device disclosed in PTL 1 described above.

In view of the above-described problems, an object of the present disclosure is to provide a control system, a control method, and a control program capable of achieving safe flight of a moving body even in a place where an operator cannot visually observe the moving body.

### Solution to Problem

A control system according to one aspect of the present disclosure includes
a movement information acquisition unit for acquiring movement information including a progress status with respect to a flight plan of a moving body,
an environmental information acquisition unit for acquiring environmental information associated with flight of the moving body from a monitoring device for monitoring a movement route of the moving body,
a recommended operation selection unit for selecting a recommended operation according to the progress status of the moving body based on the movement information and the environmental information, and
an output unit for outputting a signal indicating the recommended operation by the recommended operation selection unit.

A control method according to one aspect of the present disclosure, is executed by a computer and includes
acquiring movement information including a progress status with respect to a flight plan of a moving body,
acquiring environmental information associated with flight of the moving body from a monitoring device for monitoring a movement route of the moving body,
selecting a recommended operation according to the progress status of the moving body based on the movement information and the environmental information, and
outputting a signal indicating the recommended operation.

A control program according to one aspect of the present disclosure for causing a computer to execute processing of
acquiring movement information including a progress status with respect to a flight plan of a moving body,
acquiring environmental information associated with flight of the moving body from a monitoring device for monitoring a movement route of the moving body,
selecting a recommended operation according to the progress status of the moving body based on the movement information and the environmental information, and
outputting a signal indicating the recommended operation.

According to the present disclosure, a control system, a control method, and a control program capable of achieving a safe flight of a moving body even in a place where an operator cannot visually observe the moving body can be provided.

### BRIEF DESCRIPTION OF DRAWINGS

FIG. 1 is a block diagram illustrating a configuration of a control system according to the present disclosure.

FIG. 2 is a flowchart illustrating a control method according to the present disclosure.

FIG. 3 is a block diagram illustrating a usage example of the control system according to the present disclosure.

FIG. 4 is a schematic diagram illustrating an example in which a monitoring device monitors a movement route of a moving body.

FIG. 5 is a diagram illustrating an example of image data photographed by an imaging unit of the monitoring device.

FIG. 6 is a flowchart illustrating processing of a recommended operation selection unit in the control system according to the present disclosure.

FIG. 7 is a block diagram of the control system according to the present disclosure.

FIG. 8 is a schematic diagram illustrating an example in which two monitoring devices monitor a movement route of one moving body.

FIG. 9 is a diagram illustrating an example of image data photographed by an imaging unit of each monitoring device.

FIG. 10 is a schematic diagram illustrating an example in which a plurality of monitoring devices monitor movement routes of a plurality of moving bodies.

FIG. 11 is a block diagram illustrating a configuration example of a management device 201 and the like according to the present disclosure.

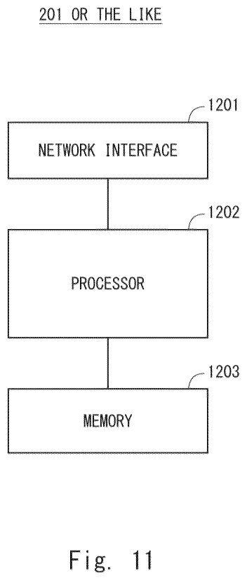

### EXAMPLE EMBODIMENT

Hereinafter, the present disclosure will be described according to example embodiments, but the disclosure described in the claims is not limited to the following example embodiments. Not all the configurations described in the example embodiments are essential as means for solving the problem. For clarity of description, the following description and drawings are omitted and simplified as appropriate. In the drawings, the same elements are denoted by the same reference numerals, and repeated description is omitted as necessary.

### First Example Embodiment

### <Control System>

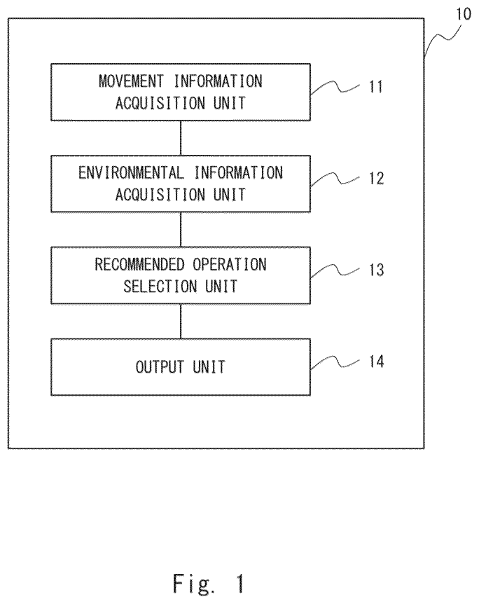

Hereinafter, a control system according to the present disclosure will be described with reference to the drawings. FIG. 1 is a block diagram illustrating a configuration of a control system according to the present disclosure. A control system 10 according to the present disclosure includes a movement information acquisition unit 11, an environmental information acquisition unit 12, a recommended operation selection unit 13, and an output unit 14. Hereinafter, the description will be given on the assumption that the operator remotely operates the moving body from a place where the moving body cannot be visually observed by using, for example, a mobile terminal or a radio controller.

The movement information acquisition unit 11 acquires movement information including the progress status with respect to the flight plan of the moving body. The moving body is a moving body that moves in the air, and is, for example, a drone (autonomous flying object) or a flying car. The moving body estimates its own position using, for example, Simultaneous Localization and Mapping (SLAM). In the SLAM, the machine body position is calculated based on an environment map that is point cloud data of the surrounding environment obtained by a distance measuring sensor such as LIDAR. The moving body flies according to the movement route in the flight plan while estimating its own position.

The progress status of the moving body with respect to the flight plan is a ratio of how much the moving body is flying with respect to the movement route in the flight plan. For example, in a case where the movement route in the flight plan of the moving body is 10 kilometers, the progress status with respect to the flight plan of the moving body is fifty percent at a point where the position of the moving body is 5 kilometers from the flight start point. Furthermore, the flight plan may include, for example, a plurality of flight relay points between the flight start position and the flight target point, and the progress status of the moving body with respect to the flight plan may indicate which flight relay point the moving body is flying.

The environmental information acquisition unit 12 acquires environmental information associated with the flight of the moving body from a monitoring device for monitoring a movement route of the moving body. The environmental information associated with the flight includes environmental information that is likely to hinder the flight of the moving body or environmental information that is unlikely to hinder the flight.

The environmental information that is likely to hinder the flight of the moving body or the environmental information that is unlikely to hinder the flight is information related to an obstacle or weather. The obstacle is, for example, a structure such as a high-rise building, nature such as a grove, a bird, another moving body, an airplane, a helicopter, or the like. The weather information is tornado, wind, rain, snow, or the like.

Adopting a case where a high-rise building having a height of 100 meters is located in the flight plan of the moving body by way of example, environmental information that is likely to hinder the flight of the moving body will be described. In a case where the moving body is planned to fly while maintaining an altitude of 90 meters, the moving body collides with a high-rise building. On the other hand, in a case where the moving body is planned to fly while maintaining an altitude of 120 meters, the moving body does not collide with a high-rise building. As described above, since there is a possibility that the moving body collides with a high-rise building having a height of 100 meters, the high-rise building having a height of 100 meters corresponds to environmental information that is likely to hinder the flight of the moving body.

Next, environmental information that is unlikely to hinder the flight will be described using a case where the moving body flies in a windless environment by way of an example. In this case, since there is no wind, the moving body flies according to the movement route of the flight plan while maintaining, for example, the flight speed. That is, the environment condition such as no wind corresponds to the environmental information that is unlikely to hinder the flight.

The recommended operation selection unit 13 selects a recommended operation according to the progress status of the moving body based on the movement information and the environmental information. The recommended operation is an appropriate flight operation of the moving body corresponding to the movement information and the environmental information. An example of the basic recommended operation is an operation of temporarily landing at a point where the moving body can safely land. However, the recommended operation is not limited to this, and the recommended operation may be changing or maintaining the flight speed of the moving body, changing or maintaining the flight altitude of the moving body, temporarily flying the moving body in a direction opposite to the movement route of the flight plan, flying the moving body on a route different from the movement route in the flight plan, or the like.

For example, in a case where the moving body is flying according to the movement route in the movement plan, but a gust is blowing, the recommended operation selection unit 13 selects the recommended operation of landing on the ground. As another example, in an environment where the moving body is flying according to the movement route in the movement plan and there is no wind, the recommended operation selection unit 13 selects the recommended operation of continuing the flight while maintaining the flight altitude and the flight speed as they are.

The output unit 14 outputs a signal indicating the recommended operation by the recommended operation selection unit 13. More specifically, the output unit 14 generates and outputs a signal indicating the recommended operation by the recommended operation selection unit 13. The output destination of the signal is, for example, a monitor of a terminal that can be confirmed by an operator who operates at a place where the moving body cannot be visually observed. As a result, even in a place where the operator cannot visually observe the moving body, the operator can manage how the moving body is flying according to the environment of the place while grasping the progress status of the moving body with respect to the flight plan. Therefore, a safe flight of the moving body can be achieved even in a place where the operator cannot visually observe the moving body.

### <Recording Method>

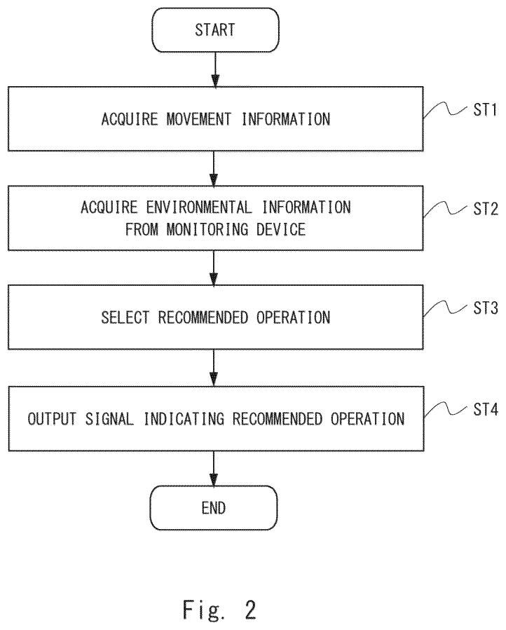

Next, a control method according to the present disclosure will be described. FIG. 2 is a flowchart illustrating a control method according to the present disclosure.

First, the movement information acquisition unit 11 acquires movement information including the progress status with respect to the flight plan of the moving body (step ST1). Next, the environmental information acquisition unit 12 acquires environmental information associated with the flight of the moving body from a monitoring device for monitoring a movement route of the moving body (step ST2). More specifically, environmental information that is likely to hinder the flight of the moving body or environmental information that is unlikely to hinder the flight is acquired.

Next, the recommended operation selection unit 13 selects a recommended operation according to the progress status of the moving body based on the movement information and the environmental information (step ST3). Then, the output unit 14 outputs a signal indicating the recommended operation (step ST4). As a result, the operator can confirm the moving body flying outside the visual observation.

As described above, the control system 10 according to the present disclosure selects the recommended operation according to the progress status of the moving body based on the movement information and the environmental information from the monitoring device. With such a configuration, even in a place where the operator cannot visually observe the moving body, the operator can manage how the moving body is flying according to the environment of the place while grasping the progress status of the moving body with respect to the flight plan. Therefore, the control system 10 according to the present disclosure can achieve safe flight of the moving body even in a place where the operator cannot visually observe the moving body.

### Second Example Embodiment

### <Control System>

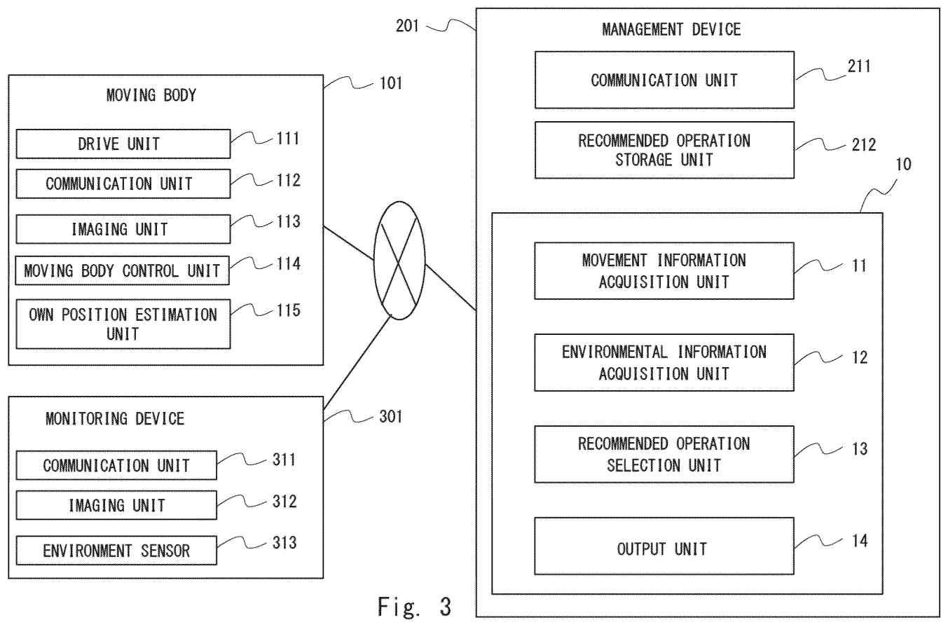

Hereinafter, a control system according to the present disclosure will be described with reference to the drawings. FIG. 3 is a block diagram illustrating a usage example of the control system according to the present disclosure. FIG. 3 illustrates the moving body 101, the management device 201, and the monitoring device 301. The moving body 101, the management device 201, and the monitoring device 301 are connected to each other in such a way as to be able to perform wireless communication. Note that, although not illustrated in FIG. 3, for example, a monitor of a terminal that is an output destination of a signal of the output unit 14 may be connected to each of the moving body 101, the management device 201, and the monitoring device 301 in such a way as to be able to perform wireless communication.

The moving body 101 includes a drive unit 111, a communication unit 112, an imaging unit 113, a moving body control unit 114, and an own position estimation unit 115. The management device 201 includes a communication unit 211, a recommended operation storage unit 212, a movement information acquisition unit 11, an environmental information acquisition unit 12, a recommended operation selection unit 13, and an output unit 14. As illustrated in FIG. 3, the management device 201 includes a control system 10. The monitoring device 301 includes a communication unit 311, an imaging unit 312, and an environment sensor 313.

### <Moving Body>

First, a configuration of the moving body 101 will be described. The drive unit 111 includes a motor for rotating a propeller that is a moving means of the moving body 101. The imaging unit 113 is a camera for photographing the vicinity or the distance. The moving body control unit 114 includes an arithmetic device such as a CPU or an MCU and controls each configuration of the moving body 101. That is, the moving body control unit 114 exchanges information with the management device 201 and the monitoring device 301 via the communication unit 112, and issues an instruction to each configuration of the moving body 101 accordingly. The own position estimation unit 115 estimates the own position using SLAM or the like.

### <Management Device>

Next, a configuration of the management device 201 will be described. Since the movement information acquisition unit 11, the environmental information acquisition unit 12, and the output unit 14 are similar to those in FIG. 1, the description thereof will be omitted. Details of the recommended operation selection unit 13 will be described later. The management device 201 exchanges information with the moving body 101 and the monitoring device 301 via the communication unit 211. Furthermore, although not illustrated in FIG. 3, the management device 201 may include a display unit, and a display unit of the management device 201 may be adopted as an output destination of a signal of the output unit 14. The recommended operation storage unit 212 includes a non-volatile memory such as a flash memory or an SSD, and stores recommended operations associated with movement information and environmental information as shown in Table 1. Table 1 is an example of the recommended operation associated with the movement information and the environmental information.

TABLE 1

| | | ENVIRONMENTAL INFORMATION | |
|---|---|---|---|
| | | NO WIND ON MOVEMENT ROUTE | TORNADO OCCURS ON MOVEMENT |
| | | OF FLIGHT PLAN | ROUTE OF FLIGHT PLAN |
| MOVEMENT | PROGRESS ACCORDING TO FLIGHT | MAINTAIN FLIGHT ALTITUDE AND | TEMPORARILY LAND ON GROUND |
| INFORMATION | PLAN | FLIGHT SPEED | |
| | PROGRESS IS DELAYED FROM | MAINTAIN FLIGHT ALTITUDE AND | TEMPORARILY LAND ON GROUND |
| | FLIGHT PLAN | FLIGHT SPEED | |
| | ROTATIONAL SPEED OF MOTOR IS | TEMPORARILY LAND ON GROUND | TEMPORARILY LAND ON GROUND |
| | HIGH | | |
| | TEMPERATURE OF MACHINE BODY | TEMPORARILY LAND ON GROUND | TEMPORARILY LAND ON GROUND |
| | (MOVING BODY) IS EQUAL TO OR | | |
| | HIGHER THAN SPECIFIED VALUE | | |
| | RADIO WAVE ENVIRONMENT IS | TEMPORARILY LAND ON GROUND | TEMPORARILY LAND ON GROUND |
| | UNSTABLE | | |

As shown in Table 1, the recommended operation storage unit 212 stores a recommended operation determined from the movement information and the environmental information. For example, in a case where the movement information is “progress according to the flight plan” and the environmental information is “no wind on the movement route of the flight plan”, a recommended operation such as “maintain flight altitude and flight speed” is determined. In addition, if the movement information is “progress according to the flight plan” and the environmental information is “tornado occurred on the movement route of the flight plan”, a recommended operation such as “temporarily land on the ground” is determined.

The ground shown in Table 1 is a point where the moving body can safely land, and is appropriately provided as a place where safety is confirmed at outside or on a rooftop of a facility, or in a town.

As shown in Table 1, the movement information may further include an operation state of the drive unit 111 of the moving body 101. In Table 1, the rotational speed of the motor is given as an example as the operation state of the drive unit 111, but this is not the sole case, and may be a rotation state of the propeller. In addition, as shown in Table 1, the movement information may include a temperature state of the machine body (moving body 101), stability of a radio wave environment of the moving body 101, and the like.

In this manner, the movement information acquisition unit 11 may acquire in what kind of operation state the moving body is flying, in addition to the progress status of the moving body at a place where the operator cannot visually observe the moving body. With such a configuration, even in a place where the operator cannot visually observe the moving body, the operator can manage how the moving body is flying according to the environment of the place while grasping in what kind of operation state the moving body is flying.

### <Monitoring Device>

Next, a configuration of the monitoring device 301 will be described. As illustrated in FIG. 3, the monitoring device 301 exchanges information with the moving body 101 and the management device 201 via the communication unit 311. The imaging unit 312 photographs environmental information associated with the flight of the moving body on the movement route of the moving body. The imaging unit 312 is, for example, a camera. The image data photographed by the imaging unit 312 includes an obstacle or weather that is likely to hinder the flight of the moving body or is unlikely to hinder the flight of the moving body. The environment sensor 313 acquires weather information on the movement route of the moving body. The environment sensor 313 is, for example, a weather sensor, an illuminance sensor, a wind direction meter, an anemometer, a thermometer, or a hygrometer.

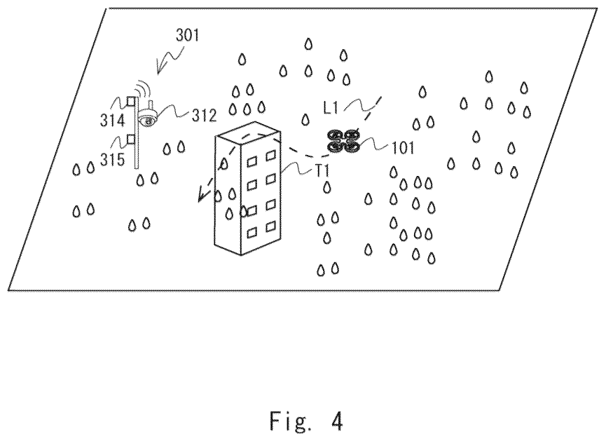

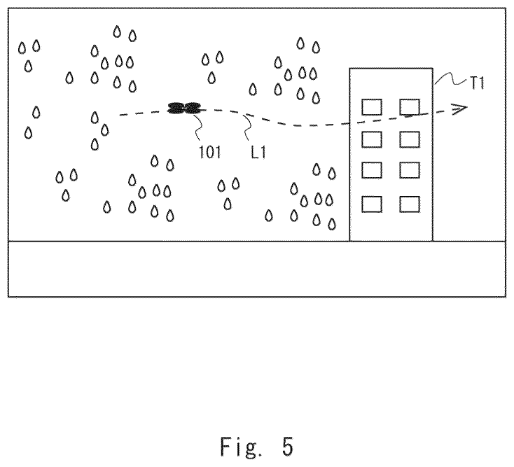

Next, the environmental information acquired by the monitoring device 301 using the imaging unit 312 or the environment sensor 313 will be described in more detail with reference to FIGS. 4 and 5. FIG. 4 is a schematic diagram illustrating an example in which the monitoring device monitors a movement route of a moving body. FIG. 5 is a diagram illustrating an example of image data photographed by the imaging unit of the monitoring device. In FIG. 4, the operator operates the moving body 101 from a place where the moving body cannot be visually observed. The operator remotely operates the moving body 101 using, for example, a mobile terminal, a radio controller, or the like. Although the environment sensor 313 is not illustrated in FIG. 4, a weather sensor 314 and an anemometer 315 are illustrated as the environment sensor 313.

As illustrated in FIG. 4, the moving body 101 is flying on the movement route L1 in the flight plan. The high-rise building T1 is located on the movement route L1. In the example illustrated in FIG. 4, it is assumed that the wind is strong and it is raining. The imaging unit 312 in the monitoring device 301 photographs environmental information regarding the flight of the moving body 101 on the movement route L1 in the flight plan. As illustrated in FIG. 5, the image data photographed by the imaging unit 312 includes an obstacle or weather that is likely to hinder the flight of the moving body. More specifically, as illustrated in FIG. 5, the image data photographed by the imaging unit 312 includes the high-rise building T11 and drops of rain. The environmental information acquisition unit 12 in the management device 201 can acquire environmental information such as the high-rise building T11 and drops of rain via the communication unit 311 and the communication unit 211.

Furthermore, although not illustrated in FIG. 4, in a case where the image data photographed by the imaging unit 312 includes a tree and the tree is tilted, the monitoring device 301 may determine that the wind is strong, and the environmental information acquisition unit 12 may acquire weather information indicating that the wind is strong.

As illustrated in FIG. 4, the monitoring device 301 includes the weather sensor 314 and the anemometer 315 as the environment sensor 313. The monitoring device 301 acquires information that it is raining on the movement route L1 in the flight plan by the weather sensor 314. In addition, the monitoring device 301 acquires the wind speed of the movement route L1 in the flight plan by the anemometer 315. As a result, the monitoring device 301 can acquire weather information indicating that the wind is strong and it is raining on the movement route. The environmental information acquisition unit 12 in the management device 201 can acquire weather information indicating that the wind is strong and it is raining via the communication unit 311 and the communication unit 211.

As described above, even if the operator is flying outside the visual observation of the moving body 101 and cannot visually observe the moving body 101, the monitoring device 301 monitors the moving body 101 in place of the operator and acquires environmental information on the movement route of the moving body 101. Therefore, in the control system according to the present disclosure, even in a place where the operator cannot visually observe the moving body, the operator can grasp surrounding environmental information in the flight route of the moving body.

### <Recommended Operation Selection>

Next, the recommended operation selection unit 13 will be described in detail. The recommended operation selection unit 13 selects a recommended operation according to the progress status of the moving body based on the movement information and the environmental information. More specifically, a corresponding recommended operation is selected from Table 1 stored in the recommended operation storage unit 212 based on the movement information and the environmental information.

However, the recommended operation selection unit 13 is not limited to the configuration of selecting the corresponding recommended operation based on the movement information and the environmental information as shown in Table 1. The recommended operation selection unit 13 may be configured to determine whether the flight state of the moving body is dangerous based on the movement information and the environmental information, and select the recommended operation according to the determination result.

More specifically, upon determining that the flight of the moving body is dangerous, the recommended operation selection unit 13 selects the recommended operation according to the progress status of the moving body from a plurality of danger avoidance operations set in advance. Upon determining that the flight of the moving body is not dangerous, the recommended operation selection unit 13 selects the recommended operation for maintaining the flight state of the moving body.

If the recommended operation selection unit 13 determines whether the flight state of the moving body is dangerous and selects the recommended operation based on the determination result, the recommended operation storage unit 212 stores, for example, information shown in Tables 2 and 3 below. Table 2 is an example of a determination table for determining whether there is danger associated with the movement information and the environmental information. Table 3 is an example of a plurality of danger avoidance operations set in advance.

TABLE 2

| | | ENVIRONMENTAL INFORMATION | |
|---|---|---|---|
| | | NO WIND ON MOVEMENT | TORNADO OCCURS ON MOVEMENT |
| | | ROUTE OF FLIGHT PLAN | ROUTE OF FLIGHT PLAN |
| MOVEMENT | PROGRESS ACCORDING TO FLIGHT | NO DANGER | DANGER |
| INFORMATION | PLAN | | |
| | PROGRESS IS DELAYED FROM FLIGHT | NO DANGER | DANGER |
| | PLAN | | |
| | ROTATIONAL SPEED OF MOTOR IS | DANGER | DANGER |
| | HIGH | | |
| | TEMPERATURE OF MACHINE BODY | DANGER | DANGER |
| | (MOVING BODY) IS EQUAL TO OR | | |
| | HIGHER THAN SPECIFIED VALUE | | |
| | RADIO WAVE ENVIRONMENT IS | DANGER | DANGER |
| | UNSTABLE | | |

TABLE 3
LIST OF DANGER AVOIDANCE OPERATIONS

DECREASE FLIGHT SPEED
LOWER FLIGHT ALTITUDE
LAND
MOVE ON ROUTE DIFFERENT FROM MOVEMENT ROUTE IN
FLIGHT PLAN
INCREASE ROTATIONAL SPEED OF MOTOR

As illustrated in Table 2, the recommended operation selection unit 13 can determine whether the flight state of the moving body is dangerous from the movement information and the environmental information. For example, in a case where the movement information is “the rotational speed of the motor is high” and the environmental information is “no wind on the movement route of the flight plan”, the recommended operation selection unit 13 can determine that the flight state of the moving body is “dangerous”. In addition, the recommended operation selection unit 13 selects at least one of a plurality of danger avoidance operations defined in Table 3 according to the progress status with respect to the flight plan.

Table 3 is an example of a plurality of danger avoidance operations set in advance, and is a recommended operation selected in a case where the recommended operation selection unit 13 determines that the flight state of the moving body is dangerous from the movement information and the environmental information. Similarly, the recommended operation storage unit 212 may store a list of recommended operations for maintaining the flight state of the moving body selected in a case where the recommended operation selection unit 13 determines that the flight state of the moving body is not dangerous from the movement information and the environmental information.

The movement information, the environmental information, and the recommended operation shown in Tables 1 and 2 are examples, and are not limited thereto. In addition, the danger avoidance operation illustrated in Table 3 is an example, and is not limited thereto. For example, the recommended operation may include switching from the automatic operation to the manual operation, and the recommended operation selection unit 13 may determine whether the flight state of the moving body is dangerous, and select switching from the automatic operation to the manual operation based on the determination result. Furthermore, the recommended operation selection unit 13 may select switching from manual operation to automatic operation.

The output unit 14 outputs a signal indicating the recommended operation by the recommended operation selection unit 13. The output unit 14 outputs a signal to the moving body control unit 114 via, for example, the communication unit 211 of the management device 201 and the communication unit 112 of the moving body 101. As a result, the moving body 101 can fly while performing the recommended operation. In addition, the output unit 14 outputs a signal to, for example, a monitor of a terminal that can be confirmed by an operator who operates a moving body at a place where the moving body cannot be visually observed. As a result, even in a place where the operator cannot visually observe the moving body, the operator can manage how the moving body is flying according to the environment of the place while grasping the progress status of the moving body with respect to the flight plan. Therefore, a safe flight of the moving body can be achieved even in a place where the operator cannot visually observe the moving body.

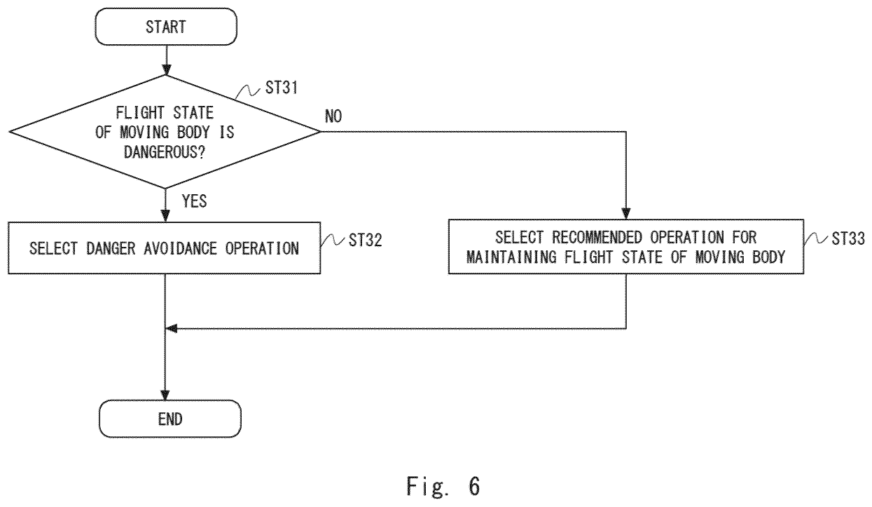

Next, a processing of recommended operation selection will be described with reference to FIG. 6. FIG. 6 is a flowchart illustrating processing of a recommended operation selection unit in the control system according to the present disclosure.

First, the recommended operation selection unit 13 determines whether the flight state of the moving body is dangerous based on the movement information and the environmental information (step ST31). For example, the recommended operation selection unit 13 determines whether the flight state of the moving body is dangerous from Table 2.

In the case where it is determined that the flight state of the moving body is dangerous (step ST31 YES), the recommended operation selection unit 13 selects a recommended operation according to the progress status of the moving body from a plurality of danger avoidance operations set in advance (step ST32). For example, the recommended operation selection unit 13 selects at least one of a plurality of danger avoidance operations defined in Table 3.

On the other hand, In the case where it is determined that the flight state of the moving body is not dangerous (step ST31 NO), the recommended operation selection unit 13 selects the recommended operation for maintaining the flight state of the moving body.

In this manner, the recommended operation selection unit 13 determines whether the flight state of the moving body is dangerous, and selects the recommended operation based on the determination result. With such a configuration, even if the operator is flying the moving body out of visual observation, an operation according to the progress status of the moving body and the environment associated with the flight can be selected. Therefore, a safe flight of the moving body can be achieved even in a place where the operator cannot visually observe the moving body.

### <Analysis of Flight State>

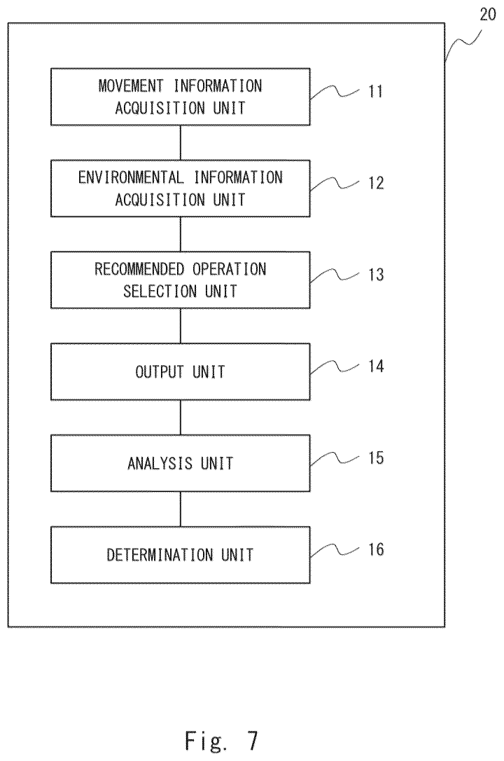

Here, in a case where the recommended operation selection unit 13 determines that the flight of the moving body is dangerous, the cause of the dangerous flight state of the moving body may be analyzed. A more specific description will be given with reference to FIG. 7. FIG. 7 is a block diagram of the control system according to the present disclosure. The control system 20 according to the present disclosure includes the movement information acquisition unit 11, the environmental information acquisition unit 12, the recommended operation selection unit 13, the output unit 14, an analysis unit 15, and a determination unit 16.

Since the movement information acquisition unit 11, the environmental information acquisition unit 12, and the output unit 14 are similar to those in FIG. 1, the description thereof will be omitted. Here, the recommended operation selection unit 13, the analysis unit 15, and the determination unit 16 will be described.

The analysis unit 15 analyzes the cause of the dangerous flight state of the moving body. More specifically, the analysis unit 15 analyzes a cause that the recommended operation selection unit 13 has determined to be dangerous. For example, in a case where the moving body is flying off the movement route in the flight plan, a case where the compass of the moving body is broken and a case where the moving body is taken over by the cyberattack are considered. The analysis unit 15 specifies which cause.

Furthermore, the analysis unit 15 uses, for example, a zero trust security model. In the zero trust security model, reliability is not unconditionally given based on a place, a position, or the like, and authentication and authorization are performed for each access to confirm reliability. That is, since the analysis unit 15 knows where the information is generated and how the information is transmitted, it is possible to analyze whether the cause is due to the cyberattack. The cyberattack is, for example, an action of hacking and extracting information related to a moving body, an action of falsifying the information, or an action of taking over the operation of the moving body.

The determination unit 16 determines whether the cause analyzed by the analysis unit 15 is a cyberattack. More specifically, in a case where the determination unit 16 determines that the cause analyzed by the analysis unit 15 is a cyberattack, the following configuration is adopted.

First, the surrounding ground residents are notified of an alert indicating that the moving body will make an emergency landing or that there is a possibility that the moving body will fall. In this case, at least one of the moving body 101 and the management device 201 illustrated in FIG. 3 includes a notification unit. Then, in a case where the determination unit 16 determines that the analyzed cause is the cyberattack, the notification unit notifies the surrounding ground residents of an alert indicating that the moving body will make an emergency landing or that there is a possibility that the moving body will fall. As a result, the control system 10 can ensure the safety of the surrounding ground residents.

Then, the recommended operation selection unit 13 selects the recommended operation in such a way as to land the moving body subjected to the cyberattack on the ground. As a result, the control system 20 can land the moving body subjected to the cyberattack on the ground, and thus collision with another moving body can be prevented.

In addition, in a case where a moving body is taken over, the moving body is forcibly landed by using a counter drone system after confirming the safety on the ground. As a result, since the moving body subjected to the cyberattack can land on the ground, collision with another moving body can be prevented. Furthermore, the recommended operation selection unit 13 may select the recommended operation in such a way as to land the another moving body flying around. As a result, the control system 10 can prevent an action of causing the moving body that has been taken over to collide with another moving body in the air as the another moving body is also landed.

On the other hand, if the determination unit 16 determines that the cause is not due to the cyberattack, the recommended operation selection unit 13 selects the recommended operation similarly to step ST32 in FIG. 6.

As described above, the control system 20 according to the present disclosure can analyze the cause of the dangerous flight state of the moving body and select an appropriate flight operation of the moving body according to the analysis result. Therefore, the control system 20 can achieve safe flight of the moving body even in a place where the operator cannot visually observe the moving body.

### Third Example Embodiment

Hereinafter, a control system according to the present disclosure will be described with reference to the drawings. Each functional block of the control system according to the present disclosure is similar to the control system 10 illustrated in FIGS. 1 and 3, and includes a movement information acquisition unit 11, an environmental information acquisition unit 12, a recommended operation selection unit 13, and an output unit 14 as illustrated in FIG. 1.

Here, it is assumed that there is one moving body operated from a place where the operator cannot visually observe the moving body, and there are a plurality of monitoring devices monitoring a movement route of the moving body. The plurality of monitoring devices monitor different regions in the movement route of the moving body. The plurality of monitoring devices are wirelessly connected to each other, and can exchange information monitored by each monitoring device.

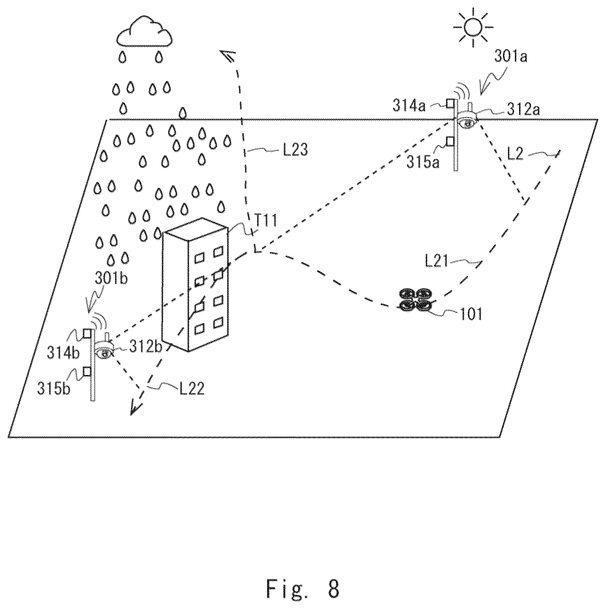

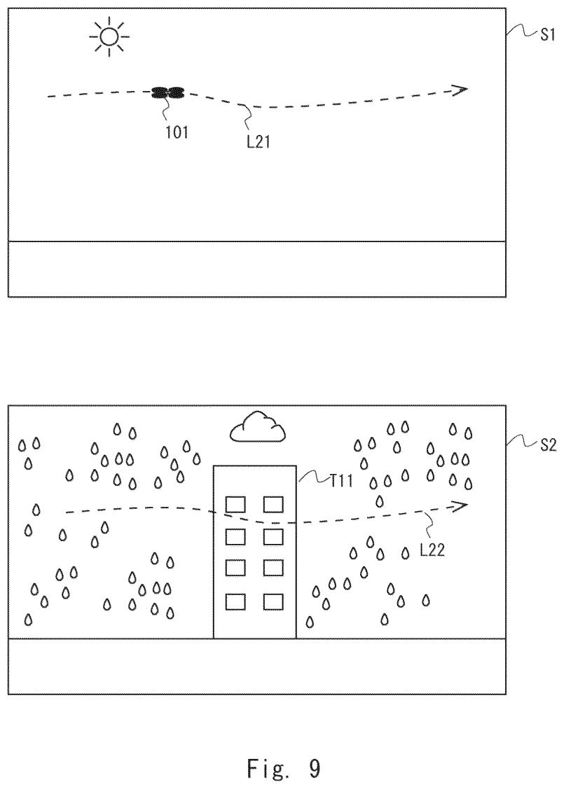

A more specific description will be given with reference to FIGS. 8 and 9. FIG. 8 is a schematic diagram illustrating an example in which two monitoring devices are monitoring a movement route of one moving body. FIG. 9 is a diagram illustrating an example of image data photographed by an imaging unit of each monitoring device. In FIG. 8, the operator operates the moving body 101 from a place where the moving body 101 cannot be visually observed. The moving body 101 flies on the movement route L2 that is a flight plan. In the example illustrated in FIG. 8, the movement route L2 of the flight plan includes a movement route L21 and a movement route L22. A movement route L23 is a movement route different from the movement route L2 of the flight plan.

As illustrated in FIG. 8, the monitoring device 301a includes a camera 312a, a weather sensor 314a, and an anemometer 315a. Similarly, the monitoring device 301b includes a camera 312b, a weather sensor 314b, and an anemometer 315b. The monitoring device 301a monitors the movement route L21 of the moving body 101. The monitoring device 301b monitors the movement route L22 of the moving body 101.

In FIG. 8, it is assumed that it is sunny around the movement route L21 monitored by the monitoring device 301a, but it is rainy around the movement route L22 monitored by the monitoring device 301b. In addition, it is assumed that the high-rise building T11 is located on the movement route L22. Furthermore, it is assumed that it is sunny around the movement route L23.

The camera 312a photographs the periphery of the movement route L21. The camera 312b photographs the periphery of the movement route L22. FIG. 9 illustrates image data obtained by photographing by the cameras 312a and 312b. The image data S1 is an image obtained by photographing by the camera 312a. The image data S2 is an image obtained by photographing by the camera 312b. The moving body 101 is flying on the movement route L21 at the timing of photographing by the monitoring device 301a and the monitoring device 301b.

As illustrated in FIG. 9, the image data S1 does not include an obstacle or weather that is likely to hinder the flight of the moving body or that is unlikely to hinder the flight of the moving body. On the other hand, the image data S2 includes a high-rise building T11 and drops of rain. In other words, the image data S2 includes an obstacle or weather that is likely to hinder the flight of the moving body.

In this case, the monitoring device 301b transmits the environmental information acquired by the monitoring device 301b, in other words, the environmental information such as the high-rise building T11 and drops of rain to the monitoring device 301a. As a result, the environmental information acquisition unit 12 (not illustrated in FIGS. 8 and 9) acquires the environmental information received by the monitoring device 301a from the monitoring device 301b.

Then, the recommended operation selection unit 13 (not illustrated in FIGS. 8 and 9) selects the recommended operation based on the movement information of the moving body 101 and the environmental information received by the monitoring device 301a from the monitoring device 302b. In the movement route L21, there is no problem in the flight of the moving body 101 because it is sunny, but in the movement route L22, there is a possibility that a problem may arise in the flight of the moving body 101 due to rain. In addition, since the high-rise building T11 is located on the movement route L22, the moving body 101 will collide during the flight.

Therefore, the recommended operation selection unit 13 (not illustrated in FIGS. 8 and 9) selects, for example, a flight operation of not flying on the movement route L22 that is a flight plan after the movement route L21, but flying on another movement route L23 to make a detour. As a result, the moving body 101 can avoid danger in advance in a case where there is danger at a position ahead of the position where the moving body is currently flying on the movement route or in a case where the environment changes.

In the examples illustrated in FIGS. 8 and 9, there are two monitoring devices 301a and 302b, but the present disclosure is not limited thereto, and the monitoring device may include at least two or more monitoring devices. The monitoring device 301a may be referred to as a first monitoring device, and the monitoring device 301b may be referred to as a second monitoring device.

As described above, the control system according to the present disclosure includes a plurality of monitoring devices monitoring different regions in the movement route of the moving body. The environmental information is exchanged among the plurality of monitoring devices. As a result, in a case where there is danger at a position ahead of the position where the moving body is currently flying on the movement route or in a case where the environment changes, the recommended operation selection unit 13 (not illustrated in FIGS. 8 and 9) can select a recommended operation for the moving body to avoid danger in advance. Therefore, the control system according to the present disclosure can achieve safer flight of the moving body.

### Fourth Example Embodiment

Hereinafter, a control system according to the present disclosure will be described with reference to the drawings. Each functional block of the control system according to the present disclosure is similar to the control system 10 illustrated in FIGS. 1 and 3, and includes a movement information acquisition unit 11, an environmental information acquisition unit 12, a recommended operation selection unit 13, and an output unit 14 as illustrated in FIG. 1.

Here, it is assumed that there are a plurality of moving bodies operated from a place where the operator cannot visually observe the moving bodies, and there are also a plurality of monitoring devices that monitor the movement routes of the moving bodies. The plurality of monitoring devices monitor different movement routes from each other or monitor different regions from each other in the movement route. The plurality of monitoring devices include at least two or more monitoring devices.

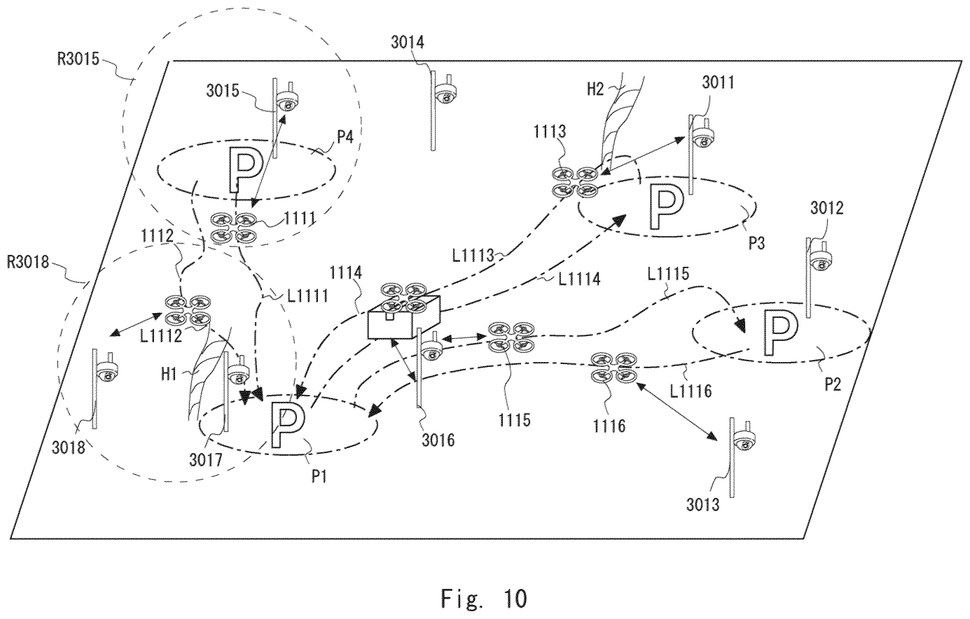

A more specific description will be given with reference to FIG. 10. FIG. 10 is a schematic diagram illustrating an example in which a plurality of monitoring devices monitor movement routes of a plurality of moving bodies. In FIG. 10, the operator operates six moving bodies 1111 to 1116 from places where the moving bodies 1111 to 1116 cannot be visually observed. As illustrated in FIG. 10, each moving body 1111 to 1116 is flying on the movement routes L1111 to L1116 in the flight plan.

As illustrated in FIG. 10, the monitoring devices 3011 to 3018 monitor movement routes different from each other or monitor regions different from each other in the movement route. In addition, each of the monitoring devices 3011 to 3018 monitors each of the movement routes L1111 to L1116 of the moving bodies 1111 to 1116 in which the movement route in the flight plan is included in the region it is monitoring. In FIG. 10, a monitoring region R3015 of the monitoring device 3015 and a monitoring region R3018 of the monitoring device 3018 are illustrated, but monitoring regions of other monitoring devices are omitted.

For example, as illustrated in FIG. 10, the monitoring device 3015 or the monitoring device 3018 includes a movement route L1111 of the moving body 1111 and a movement route L1112 of the moving body 1112 in a region R3015 or R3018 it is monitoring. As illustrated in FIG. 10, the moving body 1111 is flying in the monitoring region R3015 of the monitoring device 3015. Therefore, the monitoring device 3015 monitors the movement route L1111 of the moving body 1111 and acquires environmental information associated with the flight of the moving body 1111.

Similarly, as illustrated in FIG. 10, the moving body 1112 is flying in the monitoring region R3018 of the monitoring device 3018. Therefore, the monitoring device 3018 monitors the movement route L1112 of the moving body 1112 and acquires environmental information associated with the flight of the moving body 1112.

Although not illustrated in FIG. 10, it is assumed that each monitoring device 3011 to 3018 includes a camera and an environment sensor.

Furthermore, in FIG. 10, relay points P1 to P4 at which the moving bodies 1111 to 1116 can take off and land are illustrated. At least one monitoring device is installed at the relay points P1 to P4 in such a way as to be able to monitor the moving body 1111 to 1116 that takes off and lands. For example, as illustrated in FIG. 10, a monitoring device 3017 is installed at the relay point P1.

The movement information acquisition unit 11 (not illustrated in FIG. 10) acquires movement information including the progress status with respect to the flight plan of each moving body 1111 to 1116 or the operation state of the drive unit.

The environmental information acquisition unit 12 (not illustrated in FIG. 10) acquires environmental information associated with the flight of the moving body 1111 to 1116 from each monitoring device 3011 to 3018. For example, the environmental information acquisition unit 12 (not illustrated in FIG. 10) acquires environmental information associated with the flight of the moving body 1111 from the monitoring device 3015, and acquires environmental information associated with the flight of the moving body 1112 from the monitoring device 3018.

Then, the recommended operation selection unit 13 (not illustrated in FIG. 10) selects the recommended operation for each moving body 1111 to 1116 based on the movement information of each moving body 1111 to 1116 and the environmental information acquired from the monitoring device monitoring the movement route of the moving body.

A processing from the time the environmental information acquisition unit 12 (not illustrated in FIG. 10) acquires environmental information associated with the flight of the moving body 1111 to 1116 from the monitoring device 3011 to 3018 until if the recommended operation selection unit 13 (not illustrated in FIG. 10) selects a recommended operation for the moving body 1111 to 1116 will be described. Here, the description will be given focusing on the monitoring device 3018 and the monitoring device 3011 illustrated in FIG. 10.

As illustrated in FIG. 10, it is assumed that tornadoes H1 and H2 occurred while the moving bodies 1111 to 1116 are flying. As illustrated in FIG. 10, it is assumed that the tornado H1 occurred on the movement route L1112 and the tornado H2 occurred on the movement route L1113.

First, since the monitoring device 3018 is monitoring the movement route L1112 of the moving body 1112, it acquires the environmental information associated with the flight of the moving body 1112. Since the tornado H1 has occurred on movement route L1112 of moving body 1112, the monitoring device 3018 acquires environmental information indicating that the tornado H1 has occurred on the movement route L1112.

As a result, the environmental information acquisition unit 12 (not illustrated in FIG. 10) acquires environmental information indicating that the tornado H1 has occurred on the movement route L1112 of the moving body 1112 from the monitoring device 3018. The recommended operation selection unit 13 (not illustrated in FIG. 10) selects a recommended operation for the moving body 1112 based on the movement information of the moving body 1112 and the environmental information indicating that the tornado H1 has occurred on the movement route L1112 of the moving body 1112. If the moving body 1112 continues to fly according to the movement route L1112, the moving body will be caught in the tornado H1. Therefore, the recommended operation selection unit 13 (not illustrated in FIG. 10) selects a recommended operation for the moving body 1112 of, for example, turning back in a direction opposite to the flight plan and landing at the relay point P4.

Furthermore, since the monitoring device 3011 is monitoring the movement route L1113 of the moving body 1113, it acquires the environmental information associated with the flight of the moving body 1113. Since the tornado H2 has occurred on movement route L1113 of moving body 1113, the monitoring device 3011 acquires environmental information indicating that the tornado H2 has occurred on the movement route L1113 of the moving body 1113.

As a result, the environmental information acquisition unit 12 (not illustrated in FIG. 10) acquires environmental information indicating that the tornado H2 has occurred on the movement route L1113 of the moving body 1113 from the monitoring device 3011. The recommended operation selection unit 13 (not illustrated in FIG. 10) selects a recommended operation for the moving body 1113 based on the movement information of the moving body 1113 and the environmental information indicating that the tornado H2 has occurred on the movement route L1113 of the moving body 1113. Since the moving body 1113 has already passed through a place where the tornado H2 has occurred, the moving body can move away from the tornado H2 by continuing flying. Therefore, the recommended operation selection unit 13 (not illustrated in FIG. 10) selects the recommended operation for the moving body 1113 of, for example, moving with increased speed according to the movement route L1113 in the flight plan.

Similarly, the recommended operation selection unit 13 (not illustrated in FIG. 10) selects the recommended operation for each moving body 1111 to 1116. For example, in the example illustrated in FIG. 10, the moving body 1114, the moving body 1115, and the moving body 1116 continue flying while maintaining the same altitude and speed.

Here, a recommended operation for the moving body 1111 selected by the recommended operation selection unit 13 (not illustrated in FIG. 10) will be described. Heretofore, the description has been given on the assumption that since the moving body 1112 is flying around the monitoring device 3018, the monitoring device 3018 monitors the movement route L1112 of the moving body 1112 and acquires the environmental information associated with the flight of the moving body 1112. However, the monitoring region R3015 of the monitoring device 3018 also includes the movement route L1111 of the moving body 1111. Therefore, the monitoring device 3018 may further acquire environmental information associated with the flight of the moving body 1111.

Similarly, since the monitoring region R3015 of the monitoring device 3015 also includes the movement route L1112 of the moving body 1112, the monitoring device 3015 may acquire environmental information associated with the flight of the moving body 1112 in addition to the environmental information associated with the flight of the moving body 1111.

Furthermore, as described above with reference to FIGS. 8 and 9, information may be exchanged among the monitoring devices. Here, a recommended operation for the moving body 1111 selected by the recommended operation selection unit 13 (not illustrated in FIG. 10) will be described focusing on the monitoring device 3015 and the monitoring device 3018 illustrated in FIG. 10.

First, the monitoring device 3018 monitors the movement route L1111 and the movement route L1112, and acquires environmental information associated with the flight of the moving body 1111 and the moving body 1112. Since the tornado H1 has occurred on movement route L1112 of moving body 1112, the monitoring device 3018 acquires environmental information indicating that the tornado H1 has occurred on the movement route L1112.

Next, the monitoring device 3015 monitors the movement route L1111 and the movement route L1112, and acquires environmental information associated with the flight of the moving body 1111 and the moving body 1112. Since no tornado has occurred in the monitoring region R3015, the monitoring device 3015 acquires that there is no environmental information that might hinder the flight of the moving body 1111 and the moving body 1112.

In this case, the monitoring device 3018 transmits, to the monitoring device 3015, environmental information indicating that the tornado H1 has occurred on the movement route L1112.

As a result, the environmental information acquisition unit 12 (not illustrated in FIG. 10) acquires environmental information indicating that the tornado H1 has occurred on the movement route L1112 of the moving body 1112 from the monitoring device 3015.

The recommended operation selection unit 13 (not illustrated in FIG. 10) selects a recommended operation for the moving body 1111 based on the movement information of the moving body 1111 and the environmental information indicating that the tornado H1 has occurred on the movement route L1112 of the moving body 1112. If the moving body 1111 continues to fly along the movement route L1111, there is a risk that the moving body 1111 will be caught in the tornado H1. Therefore, the recommended operation selection unit 13 (not illustrated in FIG. 10) selects a recommended operation for the moving body 1111 of, for example, turning back in a direction opposite to the flight plan and landing at the relay point P4. As a result, the control system according to the present disclosure can allow each moving body to avoid danger in advance in a case where there is danger at a position ahead of the position where the moving body is currently flying on the movement route or in a case where the environment changes.

Here, a configuration has been described in which the monitoring device 3015 and the monitoring device 3018 exchange information, the environmental information acquisition unit 12 (not illustrated in FIG. 10) acquires the exchanged information, and the recommended operation selection unit 13 (not illustrated in FIG. 10) selects the recommended operation of the moving body 1111 based on the exchanged information. However, this is not the sole case, and the following configuration may be adopted.

The environmental information acquisition unit 12 (not illustrated in FIG. 10) acquires, from the monitoring device 3015, that there is no environmental information that might hinder the flight of the moving body 1111 and the moving body 1112. Furthermore, the environmental information acquisition unit 12 (not illustrated in FIG. 10) acquires environmental information indicating that the tornado H1 has occurred on the movement route L1112 from the monitoring device 3018. Then, the recommended operation selection unit 13 (not illustrated in FIG. 10) selects the recommended operation for the moving body 1111 based on the movement information of the moving body 1111 and the environmental information indicating that the tornado H1 has occurred on the movement route L1112 of the moving body 1112 acquired from the monitoring device 3018.

That is, the environmental information acquired by each of the monitoring devices 3011 to 3018 is transmitted to the environmental information acquisition unit 12 (not illustrated in FIG. 10) without exchanging the environmental information among the monitoring devices. Then, the recommended operation selection unit 13 (not illustrated in FIG. 10) selects the recommended operation for each moving body 1111 to 1116 based on the environmental information from each monitoring device 3011 to 3018 received by the environmental information acquisition unit 12 (not illustrated in FIG. 10).

Here, the description has been given on the assumption that each moving body is individually controlled and operated. As another example, the moving bodies may be divided into groups, and a group control may be performed. In a case where one moving body included in the group is dangerous, the recommended operation selection unit 13 (not illustrated in FIG. 10) may specify the moving body that is dangerous from the group, and select the switching from the automatic operation to the manual operation as the recommended operation for the specified moving body.

More specifically, in a case where the recommended operation selection unit 13 (not illustrated in FIG. 10) specifies a moving body that is dangerous from the group, for example, the following configuration is adopted. The output unit 14 (not illustrated in FIG. 10) outputs a signal such as “Remote ID (RID): Do you want to switch the operation of the moving body of oo to manual operation?” to a monitor of a terminal or a display unit of the management device (illustrated in FIG. 3) that can be confirmed by the operator. A moving body of Remote ID (RID): oo indicates a moving body in a dangerous state specified by the recommended operation selection unit 13 (not illustrated in FIG. 10) from the group. In a case where the operator confirms and agrees with the message displayed on the monitor of the terminal or the display unit of the management device, the moving body in the dangerous state is switched from the automatic operation to the manual operation. Then, in the case where the moving body in the dangerous state is switched from the automatic operation to the manual operation, the monitor of the terminal or the display unit of the management device becomes the operation screen. As a result, the operator can manually operate the moving body in the dangerous state while confirming the monitor of the terminal or the display unit of the management device.

In addition, in a case where a plurality of moving bodies included in the group are dangerous, and the recommended operation selection unit 13 selects switching from the automatic operation to the manual operation as the recommended operation for the plurality of dangerous moving bodies, the following configuration may be adopted.

First, the recommended operation selection unit 13 (not illustrated in FIG. 10) determines the priority of the moving body that is dangerous from the group. For example, the recommended operation selection unit 13 calculates the danger degree from the movement information and the environmental information of each moving body for each moving body determined to be dangerous. More specifically, the recommended operation selection unit 13 calculates the danger degree based on Table 4. Table 4 is an example illustrating the danger degree of the moving body based on the movement information and the environmental information. In Table 4, the danger degree is evaluated and indicated by a level of 1 to 5, where in a case where the danger degree is 1, it is indicated that the moving body is not dangerous, and the degree of danger of the moving body increases as the numerical value increases, so that in a case where the danger degree is 5, it is indicated that the moving body is most dangerous. For example, as shown in Table 4, if the movement information of the moving body is “a rotational speed of the motor is high” and the environmental information of the moving body is “a tornado has occurred on the movement route of the flight plan”, the recommended operation selection unit 13 calculates that the danger degree of the moving body is 5.

TABLE 4

| | | ENVIRONMENTAL INFORMATION | |
|---|---|---|---|
| | | NO WIND ON MOVEMENT ROUTE | TORNADO OCCURS ON MOVEMENT |
| | | OF FLIGHT PLAN | ROUTE OF FLIGHT PLAN |
| MOVEMENT | PROGRESS ACCORDING TO FLIGHT | DANGER DEGREE 1 | DANGER DEGREE 3 |
| INFORMATION | PLAN | | |
| | PROGRESS IS DELAYED FROM FLIGHT | DANGER DEGREE 1 | DANGER DEGREE 3 |
| | PLAN | | |
| | ROTATIONAL SPEED OF MOTOR IS | DANGER DEGREE 2 | DANGER DEGREE 5 |
| | HIGH | | |
| | TEMPERATURE OF MACHINE BODY | DANGER DEGREE 2 | DANGER DEGREE 5 |
| | (MOVING BODY) IS EQUAL TO OR | | |
| | HIGHER THAN SPECIFIED VALUE | | |
| | RADIO WAVE ENVIRONMENT IS | DANGER DEGREE 2 | DANGER DEGREE 4 |
| | UNSTABLE | | |

The danger degree of the moving body shown in Table 4 is merely an example evaluated and indicated by a level of 1 to 5, and may be indicated by any method as long as the priority can be determined. For example, the danger degree may be evaluated and indicated with a score of 0 to 10.

Then, the recommended operation selection unit 13 determines that the priority of the moving bodies that are dangerous is higher in order from the moving body with a high danger degree. For example, in the case of three moving bodies with the danger degrees of 3, 4, and 5, the recommended operation selection unit 13 determines that the moving body with the danger degree 5, the moving body with the danger degree 4, and the moving body with the danger degree 3 have high priorities in this order.

Next, the output unit 14 (not illustrated in FIG. 10) outputs a signal such as “RID (Remote ID): Do you want to switch the operation of the drone of o o to manual operation?” to the monitor of the terminal or the display unit of the management device that can be confirmed by the operator based on the priority. A more specific description will be given using the case of three moving bodies with the danger degrees 3, 4, and 5 by way of example. Hereinafter, a description will be given assuming that the RID of a moving body with a danger degree of 3 is D1, the RID of a moving body with a danger degree of 4 is D2, and the RID of a moving body with a danger degree of 5 is D5.

First, the output unit 14 outputs a signal such as “RID: Do you want to switch the operation of the moving body of D3 to manual operation?” to the monitor of the terminal or the display unit of the management device that can be confirmed by the operator to switch the moving body with the danger degree 5 having the highest priority from the automatic operation to the manual operation. In a case where the operator confirms and agrees with the message displayed on the monitor of the terminal or the display unit of the management device, the moving body with the danger degree 5 is switched from the automatic operation to the manual operation. Then, in the case where the moving body with the danger degree 5 is switched from the automatic operation to the manual operation, the monitor of the terminal or the display unit of the management device becomes the operation screen. As a result, the operator can manually operate the moving body with the danger degree 5 while confirming the monitor of the terminal or the display unit of the management device.

Next, the output unit 14 outputs a signal such as “RID: Do you want to switch the operation of the moving body of D2 to manual operation?” to the monitor of the terminal or the display unit of the management device that can be confirmed by the operator to switch the moving body with the danger degree 4 having the second highest priority from the automatic operation to the manual operation. Since the processing from the time the monitor of the terminal or the management device receives the signal until the operator manually operates the moving body with the danger degree 4 is similar to the case of the moving body with the danger degree 5, the description thereof will be omitted.

Next, the output unit 14 outputs a signal such as “RID: Do you want to switch the operation of the moving body of D1 to manual operation?” to the monitor of the terminal or the display unit of the management device that can be confirmed by the operator to switch the moving body with the danger degree 3 having the next highest priority from the automatic operation to the manual operation.

As described above, in a case where the recommended operation selection unit 13 selects, as the recommended operation, the switching from the automatic operation to the manual operation for a plurality of dangerous moving bodies, first, the recommended operation selection unit 13 (not illustrated in FIG. 10) determines the priority of the moving body that is dangerous from the group. Then, based on the priority, the output unit 14 transmits a signal for confirming the switching from automatic operation to manual operation to the monitor of the terminal or the display unit of the management device that can be confirmed by the operator. With such a configuration, the operator can manually operate the moving bodies preferentially from a moving body with high danger.

As described above, in the control system according to the present disclosure, the movement information of each moving body and the environmental information associated with the flight of the moving body from each monitoring device are acquired, and the recommended operation for each moving body is selected. With such a configuration, even if each moving body is flying in any place that is not visually observed by the operator, each monitoring device monitors the moving body in place of the operator. Therefore, even if there is only one operator, the operator can manage how each moving body is flying according to the environment of the place while grasping the progress status with respect to the flight plan of each moving body. Therefore, the control system according to the fourth example embodiment can achieve safe flight of the moving body even in a place where the operator cannot visually observe the moving body.

### Configuration Example

FIG. 16 is a block diagram illustrating a configuration example of the management device 201, the monitoring devices 301, 301a, 301b, and 3011 to 3018, and the moving bodies 101, 1111, 1112, 1113, 1114, 1115, and 1116 (hereinafter referred to as a management device 201 or the like) described above. Referring to FIG. 16, the management device 201 or the like includes a network interface 1201, a processor 1202, and a memory 1203. The network interface 1201 may be used to communicate with network nodes. The network interface 1201 may include, for example, a Network Interface Card (NIC) conforming to IEEE 802.3 series. The IEEE represents the Institute of Electrical and Electronics Engineers.

The processor 1202 reads and executes software (computer program) from the memory 1203 to perform processing of the management device 201 or the like described using the flowcharts in the above-described example embodiments. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage disposed away from the processor 1202. In this case, the processor 1202 may access the memory 1203 via an Input/Output (I/O) interface (not illustrated).

In the example in FIG. 16, the memory 1203 is used to save a software module group. The processor 1202 can perform the processing of the management device 201 or the like described in the above-described example embodiments by reading and executing these software module groups from the memory 1203.

As described with reference to FIG. 16, each of the processors included in the management device 201 or the like executes one or a plurality of programs including a command group for causing a computer to perform the algorithm described with reference to the drawings.

In addition, a part or all of the processing in the control system according to the present disclosure described above can be achieved as a computer program. Such a program can be stored and supplied to the computer using various types of non-transitory computer-readable media. The non-transitory computer readable media include various types of tangible control media. Examples of the non-transitory computer readable medium include a magnetic control medium (e.g., a flexible disk, a magnetic tape, or a hard disk drive), an optical magnetic control medium (e.g., a magneto-optical disk), a CD-Read Only Memory (ROM), a CD-R, a CD-R/W, and a semiconductor memory (e.g., a mask ROM, a Programmable ROM (PROM), an Erasable PROM (EPROM), a flash ROM, or a Random Access Memory (RAM)). The program may be supplied to the computer using various types of transitory computer-readable media. Examples of the transitory computer-readable media include electric signals, optical signals, and electromagnetic waves. The transitory computer-readable media can provide the program to the computer via a wired communication line such as an electric wire and optical fibers or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely an example for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other figures, for example, to create an example embodiment that is not explicitly illustrated or described. All of the features or steps illustrated in any one of the figures to explain illustrative example embodiments are not necessarily mandatory, and some features or steps may be omitted. The order of the steps described in any of the figures may be changed as appropriate.

Some or all of the above example embodiments may be described as the following Supplementary Notes, but are not limited to the following.

### (Supplementary Note 1)

A control system including:
a movement information acquisition unit for acquiring movement information including a progress status with respect to a flight plan of a moving body;
an environmental information acquisition unit for acquiring environmental information associated with flight of the moving body from a monitoring device for monitoring a movement route of the moving body;
a recommended operation selection unit for selecting a recommended operation according to the progress status of the moving body based on the movement information and the environmental information; and
an output unit for outputting a signal indicating the recommended operation by the recommended operation selection unit.

### (Supplementary Note 2)

The control system according to Supplementary Note 1, in which the movement information further includes an operation state of a drive unit of the moving body.

### (Supplementary Note 3)

The control system according to Supplementary Note 1 or 2, in which
the recommended operation selection unit determines whether a flight state of the moving body is dangerous based on the movement information and the environmental information, and
selects, in a case where it is determined that the flight of the moving body is dangerous, the recommended operation from a plurality of danger avoidance operations set in advance.

### (Supplementary Note 4)

The control system according to Supplementary Note 3, further including:
an analysis unit for analyzing a cause of a dangerous flight state of the moving body; and
a determination unit for determining whether the analyzed cause is a cyberattack,
in which the recommended operation selection unit further selects the recommended operation based on a determination result of the determination unit.

### (Supplementary Note 5)

The control system according to Supplementary Note 1 or 2, in which the environmental information is an obstacle or a weather that is likely to hinder the flight of the moving body or is unlikely to hinder the flight of the moving body included in the image data photographed by an imaging unit included in the monitoring device.

### (Supplementary Note 6)

The control system according to Supplementary Note 1 or 2, in which the environmental information is weather information of the movement route acquired by an environment sensor included in the monitoring device.

### (Supplementary Note 7)

The control system according to Supplementary Note 1 or 2, in which
the monitoring device includes at least two or more monitoring devices including a first monitoring device and a second monitoring device monitoring different regions on a movement route of the moving body,
the environmental information acquired by the second monitoring device is transmitted to the first monitoring device,
the environmental information acquisition unit acquires the environmental information received by the first monitoring device from the second monitoring device, and
the recommended operation selection unit selects a recommended operation based on the movement information and the environmental information received by the first monitoring device from the second monitoring device.

### (Supplementary Note 8)

The control system according to Supplementary Note 1 or 2, in which
the moving body includes a plurality of moving bodies,
the monitoring device includes at least two or more monitoring devices monitoring different movement routes or monitoring different regions in the movement route,
the monitoring device monitors a movement route of each moving body in which the movement route is included in a region monitored by the monitoring device,
the movement information acquisition unit acquires movement information of each moving body,
the environmental information acquisition unit acquires, from each of the monitoring devices, environmental information associated with flight of the moving body in which the movement route is included in a region monitored by the monitoring device, and
the recommended operation selection unit selects a recommended operation for each moving body based on the movement information of each moving body and the environmental information acquired from the monitoring device monitoring a movement route of the moving body.

### (Supplementary Note 9)

The control system according to Supplementary Note 1 or 2, in which the recommended operation selection unit selects switching from automatic operation to manual operation.

### (Supplementary Note 10)

A control method executed by a computer and including:
acquiring movement information including a progress status with respect to a flight plan of a moving body;
acquiring environmental information associated with flight of the moving body from a monitoring device for monitoring a movement route of the moving body;
selecting a recommended operation according to the progress status of the moving body based on the movement information and the environmental information; and
outputting a signal indicating the recommended operation.

### (Supplementary Note 11)

The control method according to Supplementary Note 10, in which the movement information further includes an operation state of a drive unit of the moving body.

### (Supplementary Note 12)

The control method according to Supplementary Note 10 or 11, further including:
determining whether a flight state of the moving body is dangerous based on the movement information and the environmental information; and
selecting, in a case where it is determined that the flight of the moving body is dangerous, the recommended operation from a plurality of danger avoidance operations set in advance.

### (Supplementary Note 13)

The control method according to Supplementary Note 12, further including:
analyzing a cause of a dangerous flight state of the moving body;
determining whether the analyzed cause is due to a cyberattack; and
selecting the recommended operation based on a determination result.

### (Supplementary Note 14)

The control method according to Supplementary Note 10 or 11, in which the environmental information is an obstacle or a weather that is likely to hinder the flight of the moving body or is unlikely to hinder the flight of the moving body included in the image data photographed by an imaging unit included in the monitoring device.

### (Supplementary Note 15)

The control method according to Supplementary Note 10 or 11, in which the environmental information is weather information of the movement route acquired by an environment sensor included in the monitoring device.

### (Supplementary Note 16)

The control method according to Supplementary Note 10 or 11, in which
the monitoring device includes at least two or more monitoring devices including a first monitoring device and a second monitoring device monitoring different regions on a movement route of the moving body, and the method further includes:
transmitting the environmental information acquired by the second monitoring device to the first monitoring device;
acquiring the environmental information received by the first monitoring device from the second monitoring device; and
selecting a recommended operation based on the movement information and the environmental information received by the first monitoring device from the second monitoring device.

### (Supplementary Note 17)

The control method according to Supplementary Note 10 or 11, in which
the moving body includes a plurality of moving bodies,
the monitoring device includes at least two or more monitoring devices monitoring different movement routes or monitoring different regions in the movement route,
the monitoring device monitors a movement route of each moving body in which the movement route is included in a region monitored by the monitoring device, and the control method further includes:
acquiring the movement information of each moving body;
acquiring the environmental information associated with flight of the moving body in which the movement route is included in a region monitored by the monitoring device from each monitoring device; and
selecting a recommended operation for each moving body based on the movement information of each moving body and the environmental information acquired from the monitoring device monitoring a movement route of the moving body.

### (Supplementary Note 18)

The control method according to Supplementary Note 10 or 11, further including selecting to switch from an automatic operation to a manual operation.

### (Supplementary Note 19)

A control program for causing a computer to execute processing of:
acquiring movement information including a progress status with respect to a flight plan of a moving body;
acquiring environmental information associated with flight of the moving body from a monitoring device for monitoring a movement route of the moving body;
selecting a recommended operation according to the progress status of the moving body based on the movement information and the environmental information; and
outputting a signal indicating the recommended operation.

### (Supplementary Note 20)

The control program according to Supplementary Note 19, in which the movement information further includes an operation state of a drive unit of the moving body.

### (Supplementary Note 21)

The control program according to Supplementary Note 19 or 20, further causing the computer to execute processing of:
determining whether a flight state of the moving body is dangerous based on the movement information and the environmental information; and
selecting, in a case where it is determined that the flight of the moving body is dangerous, the recommended operation from a plurality of danger avoidance operations set in advance.

### (Supplementary Note 22)

The control program according to Supplementary Note 21, further causing the computer to execute processing of:
analyzing a cause of a dangerous flight state of the moving body;
determining whether the analyzed cause is due to a cyberattack; and
selecting the recommended operation based on a determination result.

### (Supplementary Note 23)

The control program according to Supplementary Note 19 or 20, in which the environmental information is an obstacle or a weather that is likely to hinder the flight of the moving body or is unlikely to hinder the flight of the moving body included in the image data photographed by an imaging unit included in the monitoring device.

### (Supplementary Note 24)

The control program according to Supplementary Note 19 or 20, in which the environmental information is weather information of the movement route acquired by an environment sensor included in the monitoring device.

### (Supplementary Note 25)

The control program according to Supplementary Note 19 or 20, in which
the processing of acquiring the environmental information includes acquiring the environmental information from at least two or more of the monitoring devices monitoring different regions on a movement route of the moving body, and
the processing of selecting the recommended operation includes selecting a recommended operation based on the movement information and the environmental information from a monitoring device different from a monitoring device in which a position of the moving body included in the movement information is included in a monitoring region.

### (Supplementary Note 26)

The control program according to Supplementary Note 19 or 20, in which
the processing of acquiring the movement information includes acquiring movement information of each moving body,
the processing of acquiring the environmental information includes acquiring, from each of the monitoring devices, environmental information associated with a flight of the moving body in which the movement route is included in a region monitored by the monitoring device, and
the processing of selecting the recommended operation includes selecting a recommended operation for each moving body based on the movement information of each moving body and the environmental information acquired from a monitoring device monitoring a movement route of the moving body.
   (Supplementary note 27)

The control program according to Supplementary Note 19 or 20, further causing the computer to execute processing of selecting to switch from an automatic operation to a manual operation.

This application is based upon and claims the benefit of priority from Japanese patent application No. 2023-048277, filed on Mar. 24, 2023, the disclosure of which is incorporated herein in its entirety by reference.

### REFERENCE SIGNS LIST

10, 20 control system
11 movement information acquisition unit
12 environmental information acquisition unit
13 recommended operation selection unit
14 output unit
15 analysis unit
16 determination unit
101, 1111, 1112, 1113, 1114, 1115, 1116 moving body
111 drive unit
112 communication unit
113 imaging unit
114 moving body control unit
115 own position estimation unit
1201 network interface
1202 processor
1203 memory
201 management device
211 communication unit
212 recommended operation storage unit
monitoring device 301, 301a, 301b
3011, 3012, 3013, 3014 monitoring device
3015, 3016, 3017, 3018 monitoring device
311 communication unit
312 imaging unit
312a, 312b camera
313 environment sensor
314, 314a, 314b weather sensor
315, 315a, 315b anemometer
H1, H2 tornado
L1, L2, L21, L22, L23 movement route
L1111, L1112, L1113 movement route
L1114, L1115, L1116 movement route
P1, P2, P3, P4 relay point
R3015, R3018 monitoring region
S1, S2 image data
T1, T11 high-rise building

What is claimed is:

1. A control system comprising:
at least one memory storing instructions; and
at least one processor configured to execute the instructions to:
acquire movement information including a progress status with respect to a flight plan of a moving body;
acquire environmental information associated with flight of the moving body from a monitoring device for monitoring a movement route of the moving body;
select a recommended operation according to the progress status of the moving body based on the movement information and the environmental information; and
output a signal indicating the recommended operation by the recommended operation selection means.

2. The control system according to claim 1, wherein the movement information further includes an operation state of a drive unit of the moving body.

3. The control system according to claim 1, wherein the at least one processor is further configured to execute the instructions to:
determine whether a flight state of the moving body is dangerous based on the movement information and the environmental information, and
select, in a case where it is determined that the flight of the moving body is dangerous, the recommended operation from a plurality of danger avoidance operations set in advance.

4. The control system according to claim 3, wherein the at least one processor is further configured to execute the instructions to:
analyze a cause of a dangerous flight state of the moving body; and
determine whether the analyzed cause is a cyberattack;
select the recommended operation based on a determination result of the determination means.

5. The control system according to claim 1, wherein the environmental information is an obstacle or a weather that is likely to hinder the flight of the moving body or is unlikely to hinder the flight of the moving body included in the image data photographed by an imaging means included in the monitoring device.

6. The control system according to claim 1, wherein the environmental information is weather information of the movement route acquired by an environment sensor included in the monitoring device.

7. The control system according to claim 1, wherein
the monitoring device includes at least two or more monitoring devices including a first monitoring device and a second monitoring device monitoring different regions on a movement route of the moving body,
the environmental information acquired by the second monitoring device is transmitted to the first monitoring device,
wherein the at least one processor is further configured to execute the instructions to:
acquire the environmental information received by the first monitoring device from the second monitoring device, and
select a recommended operation based on the movement information and the environmental information received by the first monitoring device from the second monitoring device.

8. The control system according to claim 1, wherein
the moving body includes a plurality of moving bodies,
the monitoring device includes at least two or more monitoring devices monitoring different movement routes or monitoring different regions in the movement route,
the monitoring device monitors a movement route of each moving body in which the movement route is included in a region monitored by the monitoring device,
wherein the at least one processor is further configured to execute the instructions to:
acquire movement information of each moving body,
acquire, from each of the monitoring devices, environmental information associated with flight of the moving body in which the movement route is included in a region monitored by the monitoring device, and
select a recommended operation for each moving body based on the movement information of each moving body and the environmental information acquired from the monitoring device monitoring a movement route of the moving body.

9. A control method executed by a computer and comprising:
acquiring movement information including a progress status with respect to a flight plan of a moving body;
acquiring environmental information associated with flight of the moving body from a monitoring device for monitoring a movement route of the moving body;
selecting a recommended operation according to the progress status of the moving body based on the movement information and the environmental information; and
outputting a signal indicating the recommended operation.

10. The control method according to claim 9, wherein the movement information further includes an operation state of a drive unit of the moving body.

11. The control method according to claim 9, further comprising:
determining whether a flight state of the moving body is dangerous based on the movement information and the environmental information; and
selecting, in a case where it is determined that the flight of the moving body is dangerous, the recommended operation from a plurality of danger avoidance operations set in advance.

12. The control method according to claim 11, further comprising:
analyzing a cause of a dangerous flight state of the moving body;
determining whether the analyzed cause is due to a cyberattack; and
selecting the recommended operation based on a determination result.

13. The control method according to claim 9, wherein the environmental information is an obstacle or a weather that is likely to hinder the flight of the moving body or is unlikely to hinder the flight of the moving body included in the image data photographed by an imaging unit included in the monitoring device.

14. The control method according to claim 9, wherein the environmental information is weather information of the movement route acquired by an environment sensor included in the monitoring device.

15. A non-transitory computer readable medium storing a control program for causing a computer to execute processing of:
acquiring movement information including a progress status with respect to a flight plan of a moving body;
acquiring environmental information associated with flight of the moving body from a monitoring device for monitoring a movement route of the moving body;
selecting a recommended operation according to the progress status of the moving body based on the movement information and the environmental information; and
outputting a signal indicating the recommended operation.

16. The non-transitory computer readable medium storing a control program according to claim 15, wherein the movement information further includes an operation state of a drive unit of the moving body.

17. The non-transitory computer readable medium storing a control program according to claim 15, further causing the computer to execute processing of:
determining whether a flight state of the moving body is dangerous based on the movement information and the environmental information; and
selecting, in a case where it is determined that the flight of the moving body is dangerous, the recommended operation from a plurality of danger avoidance operations set in advance.

18. The non-transitory computer readable medium storing a control program according to claim 17, further causing the computer to execute processing of:
analyzing a cause of a dangerous flight state of the moving body;
determining whether the analyzed cause is due to a cyberattack; and
selecting the recommended operation based on a determination result.

19. The non-transitory computer readable medium storing a control program according to claim 15, wherein the environmental information is an obstacle or a weather that is likely to hinder the flight of the moving body or is unlikely to hinder the flight of the moving body included in the image data photographed by an imaging unit included in the monitoring device.

20. The non-transitory computer readable medium storing a control program according to claim 15, wherein the environmental information is weather information of the movement route acquired by an environment sensor included in the monitoring device.
